(19) United States
(12) Patent Application Publication
(10) Pub. No.: US 2023/0095196 A1
(43) Pub. Date: Mar. 30, 2023

(54) COLOR-STABLE CURING AGENT COMPOSITIONS COMPRISING WATER-DISPERSIBLE POLYISOCYANATES

(71) Applicant: BASF SE, Ludwigshafen am Rhein (DE)

(72) Inventors: Frederic LUCAS, Ludwigshafen am Rhein (DE); Sebastian ROLLER, Ludwigshafen am Rhein (DE)

(21) Appl. No.: 17/795,594

(22) PCT Filed: Jan. 21, 2021
(86) PCT No.: PCT/EP2021/051339

§ 371 Date: Jul. 27, 2022

(30) Foreign Application Priority Data
Jan. 30, 2020 (EP) 20154690.0

(51) Int. Cl. C08K 5/13; C09D 175/08; C08G 18/08; C08G 18/79; C08G 18/70; C08G 18/28

(52) U.S. Cl. CPC C08K 5/13; C09D 175/08; C08G 18/0819; C08G 18/792; C08G 18/706; C08G 18/283; C08G 18/288

(57) ABSTRACT

A polyisocyanate composition comprising (A) at least one polyisocyanate obtainable by reacting (c) at least one diisocyanate or polyisocyanate, (d) at least one surfactant comprising a mixture of compounds based on the following formulae (I) and (II); in which R¹ and R² independently of one another are alkyl, cycloalkyl or aryl, it being possible for each of the stated radicals to be substituted by aryl, alkyl, aryloxy, alkyloxy, heteroatoms and/or heterocycles, said mixture of compounds of formulae (I) and (II) being characterised in that the molar ratio between compound (II), i.e. the monoester-type compound, and compound (I), i.e. the diester-type compound, is from 5:95 to 95:5, and (c) at least one monofunctional polyalkylene glycol, —and (B) at least one sterically hindered phenol.

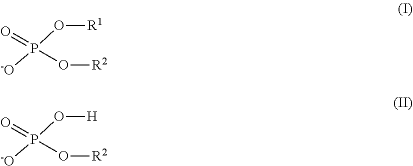

The present invention relates to new, color-drift-stable compositions of water-dispersible polyisocyanates of (cyclo)aliphatic diisocyanates.

U.S. Pat. No. 6,376,584 B1 describes various stabilizers for use in polyurethane compositions in which polyisocyanates are reacted with polyols in the presence of dibutyltin dilaurate.

U.S. Pat. No. 7,122,588 B2 describes coating materials, including polyurethane coating materials, which are stabilized with esters of hypophosphorous acid for the purpose of longer life and to counter discoloration.

The stabilization described therein is still not sufficient, and so there continues to be a need for improved stabilization.

DE 19630903 describes the stabilization of isocyanates with the aid of various phosphorus compounds and phenols.

WO 2005/089085 describes polyisocyanate compositions as curing agents for 2K (two component) polyurethane coating materials that in addition to a catalyst for the reaction between isocyanate groups and groups reactive therewith comprises a stabilizer mixture selected from hindered phenols and secondary arylamines and also organophosphites, more particularly trialkyl phosphites. Explicitly disclosed in the examples is a polyisocyanate composition, the isocyanurate Tolonate HDT, with dibutyltin dilaurate as catalyst in butyl acetate/methyl amyl ketone/xylene 1:1:0.5.

A disadvantage of phosphites, however, particularly of trialkyl phosphites and more particularly of tributyl phosphite, is that they have a very unpleasantly reeking odor. In terms of toxicological classification, tributyl phosphite is injurious to health on contact with the skin, and corrosive. Triphenyl phosphite is irritant to eyes and skin, and highly toxic for aquatic organisms. Phosphites, moreover, are sensitive to moisture. Consequently these compounds, at least before and during incorporation into polyisocyanate compositions, represent a problem from the standpoints of health, occupational hygiene, and processing. Whereas the antioxidative action of aromatic phosphites is lower than that of their aliphatic counterparts, the availability of the aliphatic phosphites is poorer.

The product mixtures described in patent specifications WO 2008/116893, WO 2008/116894, and WO 2008/116895 mandatorily comprise polyisocyanate, Lewis acid, primary antioxidant (sterically hindered phenol), and secondary antioxidant: thio compound (WO 2008/116893), phosphonite (WO 2008/116895) or phosphonate (WO 2008/116894). In addition, they may optionally comprise an acidic stabilizer, which is a Brønsted acid. Those contemplated include organic carboxylic acids, carbonyl chlorides, inorganic acids, such as phosphoric acid, phosphorous acid, and hydrochloric acid, for example, and diesters, examples being the alkyl diesters and/or aryl diesters of phosphoric acid and/or phosphorous acid, or inorganic acid chlorides such as phosphorus oxychloride or thionyl chloride, for example. Finding preferred use as acidic stabilizers are aliphatic monocarboxylic acids having 1 to 8 C atoms, such as formic acid and acetic acid, for example, and aliphatic dicarboxylic acids having 2 to 6 C atoms, such as oxalic acid and more particularly 2-ethylhexanoic acid, for example, chloropropionic acid and/or methoxyacetic acid. Alkyl and/or aryl diesters of phosphoric acid are not said to be preferred. Sulfonic acid derivatives are not stated.

These Brønsted acids specified in the patent applications are used more particularly in order to prevent viscosity rise, or even gelling, of polyisocyanates in bulk, i.e. without solvent. Thus WO 2008/068197 describes the corresponding use of methoxyacetic acid, EP 643042 likewise a corresponding use. The use for reducing color on storage in synergy with sterically hindered phenols is not described.

It is an object of the present invention to provide further storage-stable water-dispersible polyisocyanate compositions whose stabilizers, in terms of odor, toxicology and/or moisture sensitivity, allow unproblematic occupational hygiene and health, and whose stabilizing action is at least comparable with that of the prior art.

This object has been achieved by polyisocyanate compositions comprising
(A) at least one polyisocyanate obtainable by reacting
   (a) at least one diisocyanate or polyisocyanate,
   (b) at least one surfactant comprising a mixture of compounds based on the following formulae (I) and (II):

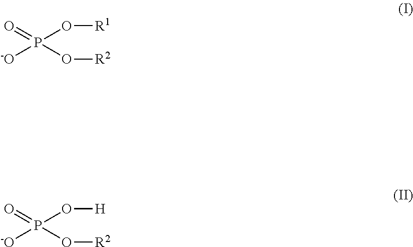

in which
R¹ and R² independently of one another are alkyl, cycloalkyl or aryl, it being possible for each of the stated radicals to be substituted by aryl, alkyl, aryloxy, alkyloxy, heteroatoms and/or heterocycles,
   said mixture of compounds of formulae (I) and (II) being characterised in that the molar ratio between compound (II), i.e. the monoester-type compound, and compound (I), i.e. the diester-type compound, is from 5:95 to 95:5,
   and
      (c) at least one monofunctional polyalkylene glycol,
         and (B) at least one sterically hindered phenol.

Polyisocyanate compositions of this kind feature good color stability over time on storage (“color drift”) and can be reacted with components comprising isocyanate-reactive groups in polyurethane coating materials.

Synthesis component (a) is at least one, one to three for example, one to two for preference, and more preferably precisely one diisocyanate or polyisocyanate.

The monomeric isocyanates used may be aromatic, aliphatic or cycloaliphatic, preferably aliphatic or cycloaliphatic, which is referred to for short in this text as (cyclo)aliphatic. Aliphatic isocyanates are particularly preferred.

Aromatic isocyanates are those which comprise at least one aromatic ring system, in other words not only purely aromatic compounds but also araliphatic compounds.

Cycloaliphatic isocyanates are those which comprise at least one cycloaliphatic ring system.

Aliphatic isocyanates are those which comprise exclusively linear or branched chains, i.e., acyclic compounds.

The monomeric isocyanates are preferably diisocyanates, which carry precisely two isocyanate groups. They can, however, in principle also be monoisocyanates having an isocyanate group.

In principle, higher isocyanates having on average more than 2 isocyanate groups are also possible. Suitability is possessed for example by triisocyanates, such as triisocyanatononane, 2,6-diisocyanato-1-hexanoic acid 2′-isocyanatoethyl ester, 2,4,6-triisocyanatotoluene, triphenylmethane triisocyanate or 2,4,4′-triisocyanatodiphenyl ether, or the mixtures of diisocyanates, triisocyanates, and higher polyisocyanates that are obtained, for example, by phosgenation of corresponding aniline/formaldehyde condensates and represent methylene-bridged polyphenyl polyisocyanates and the corresponding ring-hydrogenated isocyanates.

These monomeric isocyanates do not contain any substantial products of reaction of the isocyanate groups with themselves.

The monomeric isocyanates are preferably isocyanates having 4 to 20 carbon atoms. Examples of typical diisocyanates are aliphatic diisocyanates such as tetramethylene diisocyanate, pentamethylene 1,5-diisocyanate, hexamethylene diisocyanate (1,6-diisocyanatohexane), octa-methylene diisocyanate, decamethylene diisocyanate, dodecamethylene diisocyanate, tetra-decamethylene diisocyanate, derivatives of lysine diisocyanate (e.g. lysine methyl ester diisocyanate, lysine ethyl ester diisocyanate), trimethylhexane diisocyanate or tetramethylhexane diisocyanate, cycloaliphatic diisocyanates such as 1,4-, 1,3- or 1,2-diisocyanatocyclo-hexane, 4,4′- or 2,4′-di(isocyanatocyclohexyl)methane, 1-isocyanato-3,3,5-trimethyl-5-(iso-cyanatomethyl)cyclohexane (isophorone diisocyanate), 1,3- or 1,4-bis(isocyanatomethyl)cyclohexane or 2,4-, or 2,6-diisocyanato-1-methylcyclohexane, and also 3 (or 4), 8 (or 9)-bis(isocy-anatomethyl)tricyclo[5.2.1.0^{2,6}]decane isomer mixtures, and also aromatic diisocyanates such as tolylene 2,4- or 2,6-diisocyanate and the isomer mixtures thereof, m- or p-xylylene diisocyanate, 2,4′- or 4,4′-diisocyanatodiphenylmethane and the isomer mixtures thereof, phenylene 1,3- or 1,4-diisocyanate, 1-chlorophenylene 2,4-diisocyanate, naphthylene 1,5-diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Particular preference is given to hexamethylene 1,6-diisocyanate, 1,3-bis(isocyanatomethyl)-cyclohexane, isophorone diisocyanate, and 4,4′- or 2,4′-di(isocyanatocyclohexyl)methane, very particular preference to isophorone diisocyanate and hexamethylene 1,6-diisocyanate, and especial preference to hexamethylene 1,6-diisocyanate.

Mixtures of said isocyanates may also be present.

Isophorone diisocyanate is usually in the form of a mixture, specifically a mixture of the cis and trans isomers, generally in a proportion of about 60:40 to 80:20 (w/w), preferably in a proportion of about 70:30 to 75:25, and more preferably in a proportion of approximately 75:25.

Dicyclohexylmethane 4,4′-diisocyanate may likewise be in the form of a mixture of the different cis and trans isomers.

For the present invention it is possible to use not only those diisocyanates obtained by phosgenating the corresponding amines but also those prepared without the use of phosgene, i.e., by phosgene-free processes. According to EP-A-0 126 299 (U.S. Pat. No. 4,596,678), EP-A-126 300 (U.S. Pat. No. 4,596,679), and EP-A-355 443 (U.S. Pat. No. 5,087,739), for example, (cyclo)aliphatic diisocyanates, such as hexamethylene 1,6-diisocyanate (HDI), isomeric aliphatic diisocyanates having 6 carbon atoms in the alkylene radical, 4,4′- or 2,4′-di(isocyanatocyclohexyl)methane, and 1-iso-cyanato-3-isocyanatomethyl-3,5,5-trimethylcyclohexane (isophorone diisocyanate or IPDI), for example, can be prepared by reacting the (cyclo)aliphatic diamines with, for example, urea and alcohols to give (cyclo)aliphatic biscarbamic esters and subjecting said esters to thermal cleavage into the corresponding diisocyanates and alcohols. The synthesis takes place usually continuously in a circulation process and in the presence, if appropriate, of N-unsubstituted carbamic esters, dialkyl carbonates, and other by-products recycled from the reaction process. Diisocyanates obtained in this way generally contain a very low or even unmeasurable fraction of chlorinated compounds, which is advantageous, for example, in applications in the electronics industry.

In one embodiment of the present invention the isocyanates used have a total hydrolyzable chlorine content of less than 200 ppm, preferably of less than 120 ppm, more preferably less than 80 ppm, very preferably less than 50 ppm, in particular less than 15 ppm, and especially less than 10 ppm. This can be measured by means, for example, of ASTM specification D4663-98. Of course, though, monomeric isocyanates having a higher chlorine content can also be used, of up to 500 ppm, for example.

It will be appreciated that it is also possible to employ mixtures of those monomeric isocyanates which have been obtained by reacting the (cyclo)aliphatic diamines with, for example, urea and alcohols and cleaving the resulting (cyclo)aliphatic biscarbaminic esters, with those diisocyanates which have been obtained by phosgenating the corresponding amines.

The polyisocyanates (a) to which the monomeric isocyanates can be oligomerized are generally characterized as follows:

The average NCO functionality of such compounds is in general at least 1.8 and can be up to 8, preferably 2 to 5, and more preferably 2.4 to 4.

The isocyanate group content after oligomerization, calculated as NCO=42 g/mol, is generally from 5% to 25% by weight unless otherwise specified.

The polyisocyanates (a) are preferably compounds as follows:
1) Polyisocyanates containing isocyanurate groups and derived from aromatic, aliphatic and/or cycloaliphatic diisocyanates. Particular preference is given in this context to the corresponding aliphatic and/or cycloaliphatic isocyanatoisocyanurates and in particular to those based on hexamethylene diisocyanate and isophorone diisocyanate. The isocyanurates present are, in particular, tris-isocyanatoalkyl and/or trisisocyanatocycloalkyl isocyanurates, which constitute cyclic trimers of the diisocyanates, or are mixtures with their higher homologs containing more than one isocyanurate ring. The isocyanatoisocyanurates generally have an NCO content of 10% to 30% by weight, in particular 15% to 25% by weight, and an average NCO functionality of 2.6 to 8.
2) Polyisocyanates containing uretdione groups and having aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates.
   The polyisocyanates containing uretdione groups are obtained in the context of this invention as a mixture with other polyisocyanates, more particularly those specified under 1). For this purpose the diisocyanates can be reacted under reaction conditions under which not only uretdione groups but also the other polyisocyanates are formed, or the uretdione groups are formed first of all and are subsequently reacted to give the other polyisocyanates, or the diisocyanates are first reacted to give the other polyisocyanates, which are subsequently reacted to give products containing uretdione groups.
3) Polyisocyanates containing biuret groups and having aromatically, cycloaliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of 18% to 22% by weight and an average NCO functionality of 2.8 to 6.
4) Polyisocyanates containing urethane and/or allophanate groups and having aromatically, aliphatically or cycloaliphatically attached, preferably aliphatically or cycloaliphatically attached, isocyanate groups, such as may be obtained, for example, by reacting excess amounts of diisocyanate, such as of hexamethylene diisocyanate or of isophorone diisocyanate, with mono- or polyhydric alcohols (a). These polyisocyanates containing urethane and/or allophanate groups generally have an NCO content of 12% to 24% by weight and an average NCO functionality of 2.1 to 4.5. Polyisocyanates of this kind containing urethane and/or allophanate groups may be prepared without catalyst or, preferably, in the presence of catalysts, such as ammonium carboxylates or ammonium hydroxides, for example, or allophanatization catalysts, such as Zn(II) compounds, for example, in each case in the presence of monohydric, dihydric or polyhydric, preferably monohydric, alcohols. The polyisocyanates containing urethane and/or allophanate groups can also be prepared in a mixture with other polyisocyanates, more particularly those specified under 1).
5) Polyisocyanates comprising oxadiazinetrione groups, derived preferably from hexamethylene diisocyanate or isophorone diisocyanate. Polyisocyanates of this kind comprising oxadiazinetrione groups are accessible from diisocyanate and carbon dioxide.
6) Uretonimine-modified polyisocyanates.
7) Carbodiimide-modified polyisocyanates.
8) Hyperbranched polyisocyanates, of the kind known for example from DE-A1 10013186 or DE-A1 10013187.
9) Polyurethane-polyisocyanate prepolymers, from di- and/or polyisocyanates with alcohols.
10) Polyurea-polyisocyanate prepolymers.
11) The polyisocyanates 1)-10), preferably 1), 3) and 4) can be converted, following their preparation, into polyisocyanates containing biuret groups or urethane/allophanate groups and having aromatically, cycloaliphatically or aliphatically attached, preferably (cyclo)aliphatically attached, isocyanate groups. The formation of biuret groups, for example, is accomplished by addition of water, water donor compounds (e.g., tert-butanol), or by reaction with amines. The formation of urethane and/or allophanate groups is accomplished by reaction with monohydric, dihydric or polyhydric, preferably monohydric, alcohols, in the presence if appropriate of suitable catalysts. These polyisocyanates containing biuret or urethane/allophanate groups generally have an NCO content of 18% to 22% by weight and an average NCO functionality of 2.8 to 6.
13) Modified polyisocyanates for dual cure applications, i.e., polyisocyanates which as well as the groups described under 1-12 also comprise groups resulting formally from addition of molecules containing NCO-reactive groups and UV-crosslinkable or actinic-radiation-crosslinkable groups to the isocyanate groups of above molecules. These molecules are, for example, hydroxyalkyl (meth)acrylates and other hydroxyl-vinyl compounds.

The diisocyanates or polyisocyanates recited above may also be present at least partly in blocked form.

Classes of compounds used for blocking are described in D. A. Wicks, Z. W. Wicks, Progress in Organic Coatings, 36, 148-172 (1999), 41, 1-83 (2001) and also 43, 131-140 (2001).

Examples of classes of compounds used for blocking are phenols, imidazoles, triazoles, pyrazoles, oximes, N-hydroxyimides, hydroxyl benzoic esters, secondary amines, lactams, CH-acidic cyclic ketones, malonic esters or alkyl acetoacetates.

In one preferred embodiment of the present invention the polyisocyanate (a) is selected from the group consisting of isocyanurates, biurets, urethanes and allophanates, preferably from the group consisting of isocyanurates, urethanes and allophanates, more preferably from the group consisting of isocyanurates and allophanates; in particular it is a polyisocyanate containing isocyanurate groups.

In one particularly preferred embodiment the polyisocyanate (a) encompasses polyisocyanates comprising isocyanurate groups and obtained from hexamethylene 1,6-diisocyanate.

In one further particularly preferred embodiment the polyisocyanate (a) encompasses a mixture of polyisocyanates comprising isocyanurate groups and obtained from hexamethylene 1,6-diisocyanate and from isophorone diisocyanate and/or pentamethylene 1,5-diisocyanate

In this specification the viscosity at 23° C. in accordance with DIN EN ISO 3219/A.3 is specified, in a cone/plate system at a shear rate of 250 s⁻¹, unless noted otherwise.

Synthesis Component (b)

The composition according to the invention particularly advantageously contains a mixture of compounds based on the following formulae (I) and (II):

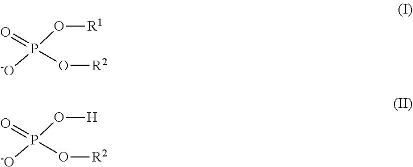

R¹ and R² being as defined above for formulae (I) and (II).

R¹ and R² independently of one another are alkyl, cycloalkyl or aryl, it being possible for each of the stated radicals to be substituted by aryl, alkyl, aryloxy, alkyloxy, heteroatoms and/or heterocycles.

Definitions therein are as follows:

C₁-C₁₈ alkyl substituted if appropriate by aryl, alkyl, aryloxy, alkyloxy, heteroatoms and/or heterocycles is for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)ethyl, p-chloro-benzyl, 2,4-dichlorobenzyl, p-methoxybenzyl, m-ethoxybenzyl, 2-cyanoethyl, 2-cyanopropyl, 2-methoxycarbonethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoro-methyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl,

C₆-C₁₂ aryl substituted if appropriate by aryl, alkyl, aryloxy, alkyloxy, heteroatoms and/or heterocycles is for example phenyl, tolyl, xylyl, α-naphthyl, β-naphthyl, 4-biphenylyl, chloro-phenyl, dichlorophenyl, trichlorophenyl, difluorophenyl, methylphenyl, dimethylphenyl, trimethylphenyl, ethylphenyl, diethylphenyl, iso-propylphenyl, tert-butylphenyl, dodecylphenyl, methoxy-phenyl, dimethoxyphenyl, ethoxyphenyl, hexyloxyphenyl, methylnaphthyl, isopropyl-naphthyl, chloronaphthyl, ethoxynaphthyl, 2,6-di methyl phenyl, 2,4,6-trimethylphenyl, 2,6-di-methoxy-phenyl, 2,6-dichlorophenyl, 4-bromophenyl, 2- or 4-nitrophenyl, 2,4- or 2,6-dinitro-phenyl, 4-dimethylaminophenyl, 4-acetylphenyl, methoxyethylphenyl or ethoxymethylphenyl, and

C₅-C₁₂ cycloalkyl substituted if appropriate by aryl, alkyl, aryloxy, alkyloxy, heteroatoms and/or heterocycles is for example cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclo-hexyl, dichlorocyclohexyl, dichlorocyclopentyl, and a saturated or unsaturated bicyclic system such as norbornyl or norbornenyl, for example.

C₁₀-C₃₀ alkyl is for example n-Decyl, 2-Propylheptyl, n-Undecyl, iso-Undecyl, n-Dodecyl, n-Tridecyl, iso-Tridecyl, Ethylundecyl, Methyldodecyl, 3,3,5,5,7-Pentamethyloctyl, n-Tetradecyl, n-Pentadecyl, n-Hexadecyl, n-Heptadecyl, iso-Heptadecyl, 3,3,5,5,7,7,9-Heptamethyldecyl, n-Octadecyl and n-Eicosyl.

Preferably R¹ and R² independently of one another can be unsubstituted alkyl or unsubstituted aryl, more preferably methyl, ethyl, isopropyl, tert-butyl, hexyl, octyl, nonyl, decyl, dodecyl, phenyl or naphthyl, very preferably phenyl, methyl, ethyl, n-butyl, and 2-ethylhexyl, and more particularly ethyl, n-butyl, and 2-ethylhexyl.

Examples of compounds (b) are monocetyl phosphate, dicetyl phosphate, cetearyl phosphate, dicetearyl phosphate.

The compounds (b) are preferably mono methyl phosphate, di methyl phosphate, mono ethyl phosphate, di ethyl phosphate, mono n-butyl phosphate, di n-butyl phosphate, mono 2-ethyl-hexyl phosphate, di 2-ethylhexyl phosphate, and mixtures thereof.

The mixture of compounds of formulae (I) and (II) is characterised in that the molar ratio between compound (II), i.e. the monoester-type compound, and compound (I), i.e. the diester-type compound, is from 5:95 to 95:5, preferably from 20:80 to 80:20, particularly preferably from 30:70 to 70:30 and especially preferably from 33:67 to 67:33.

Component (c) encompasses monofunctional polyalkylene oxide polyether alcohols, which are reaction products of suitable starter molecules with polyalkylene oxides.

Suitable starter molecules for preparing monohydric polyalkylene oxide polyether alcohols are thiol compounds, monohydroxy compounds of the general formula

R⁴—O—H

or secondary monoamines of the general formula

R⁵R⁶N—H,

in which

R⁴, R⁵ and R⁶ each independently of one another are C₁-C₂₀ alkyl, C₂-C₂₀ alkyl uninterrupted or interrupted by one or more oxygen and/or sulfur atoms and/or by one or more substituted or unsubstituted imino groups, or C₆-C₁₂ aryl, C₅-C₁₂ cycloalkyl or a five- to six-membered heterocycle containing oxygen, nitrogen and/or sulfur atoms, or R⁵ and R⁶ together form an unsaturated, saturated or aromatic ring which is uninterrupted or interrupted by one or more oxygen and/or sulfur atoms and/or by one or more substituted or unsubstituted imino groups, it being possible for the stated radicals to be substituted in each case by functional groups, aryl, alkyl, aryloxy, alkyloxy, halogen, heteroatoms and/or heterocycles.

Preferably R⁴, R⁵, and R⁶ independently of one another are C₁- to C₄ alkyl, i.e., methyl, ethyl, isopropyl, n-propyl, n-butyl, isobutyl, sec-butyl or tert-butyl; more preferably R⁴, R⁵, and R⁶ are methyl.

Examples of suitable monovalent starter molecules are saturated monoalcohols such as methanol, ethanol, n-propanol, isopropanol, n-butanol, isobutanol, sec-butanol, the isomeric pentanols, hexanols, octanols, and nonanols, n-decanol, n-dodecanol, n-tetradecanol, n-hexadecanol, n-octadecanol, cyclohexanol, cyclopentanol, the isomeric methylcyclohexanols or hydroxymethylcyclohexane, 3-ethyl-3-hydroxy-methyloxetane, or tetrahydrofurfuryl alcohol; unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol; secondary monoamines such as dimethyl-amine, diethylamine, dipropylamine, diisopropylamine, di-n-butylamine, diisobutylamine, bis(2-ethyl-hexyl)amine, N-methyl- and N-ethylcyclohexylamine or dicyclohexylamine, hetero-cyclic secondary amines such as morpholine, pyrrolidine, piperidine or 1H-pyrazole, and also amino alcohols such as 2-dimethylaminoethanol, 2-diethylaminoethanol, 2-diisopropylamino-ethanol, 2-dibutylaminoethanol, 3-(dimethylamino)-1-propanol or 1-(dimethylamino)-2-propanol.

Examples of polyethers prepared starting from amines are the Jeffamine® M series, which represent methyl-capped polyalkylene oxides with an amino function, such as M-600 (XTJ-505), having a propylene oxide (PO)/ethylene oxide (EO) ratio of approximately 9:1 and a molar mass of approximately 600, M-1000 (XTJ-506): PO/EO ratio 3:19, molar mass approximately 1000, M-2005 (XTJ-507): PO/EO ratio 29:6, molar mass approximately 2000, or M-2070: PO/EO ratio 10:31, molar mass approximately 2000.

Alkylene oxides suitable for the alkoxylation reaction are ethylene oxide, propylene oxide, isobutylene oxide, vinyloxirane and/or styrene oxide, which may be used in any order or else in a mixture in the alkoxylation reaction.

Preferred alkylene oxides are ethylene oxide, propylene oxide, and their mixtures; ethylene oxide is particularly preferred.

Preferred polyether alcohols are those which are based on polyalkylene oxide polyether alcohols in whose preparation saturated aliphatic or cycloaliphatic alcohols of the above-mentioned kind were used as starter molecules. Very particular preference is given to those based on polyalkylene oxide polyether alcohols prepared using saturated aliphatic alcohols having 1 to 4 carbon atoms in the alkyl radical. Particular preference is given to polyalkylene oxide polyether alcohols prepared starting from methanol.

The monohydric polyalkylene oxide polyether alcohols have on average in general at least two alkylene oxide units, preferably at least 5 alkylene oxide units, per molecule, more preferably at least 7, and very preferably at least 10 alkylene oxide units, more particularly ethylene oxides unit.

The monohydric polyalkylene oxide polyether alcohols have on average in general up to 50 alkylene oxide units per molecule, preferably up to 45, more preferably up to 40, and very preferably up to 30 alkylene oxide units, more particularly ethylene oxide units.

The molar weight of the monohydric polyalkylene oxide polyether alcohols is preferably up to 4000, more preferably not above 2000 g/mol, very preferably not below 250 and more particularly 500±100 g/mol.

Preferred polyether alcohols are therefore compounds of the formula

R⁴—O—[—Xᵢ—]ₖ—H

in which

R⁴ is as defined above,

k is an integer from 5 to 40, preferably 7 to 20, and more preferably 10 to 15, and

each X for i=1 to k can be selected independently from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group consisting of —CH₂—CH₂—O—, —CH₂—CH(CH₃)—O— and —CH(CH₃)—CH₂—O—, and more preferably —CH₂—CH₂—O— in which Ph is phenyl and Vin is vinyl.

The polyalkylene oxide polyether alcohols are generally prepared by alkoxylating the starter compounds in the presence of a catalyst, such as of an alkali metal or alkaline earth metal hydroxide, oxide, carbonate or hydrogencarbonate, for example.

The polyalkylene oxide polyether alcohols can also be prepared with the aid of multimetal cyanide compounds, frequently also referred to as DMC catalysts, which have been known for a long time and have been widely described in the literature, as for example in U.S. Pat. No. 3,278,457 and in U.S. Pat. No. 5,783,513.

The DMC catalysts are typically prepared by reacting a metal salt with a cyanometalate compound. To enhance the properties of the DMC catalysts it is customary to add organic ligands during and/or after the reaction. A description of the preparation of DMC catalysts is found, for example, in U.S. Pat. No. 3,278,457.

Typical DMC catalysts have the following general formula:

M¹ₐ[M²(CN)_{b}]_{d}.fM¹ⱼXₖ.h(H₂O)eL.zP

in which
M¹ is a metal ion selected from the group comprising Zn²⁺, Fe²⁺, Fe³⁺, Co²⁺, Co³⁺, Ni²⁺, Mn²⁺, Sn²⁺, Sn⁴⁺, Pb²⁺, Al³⁺, Sr²⁺, Cr³⁺, Cd²⁺, Cu²⁺, La³⁺, Ce³⁺, Ce⁴⁺, Eu³⁺, Mg²⁺, Ti⁴⁺, Ag⁺, Rh²⁺, Ru²⁺, Ru³⁺, Pd2+,
   M² is a metal ion selected from the group comprising Fe²⁺, Fe³⁺, Co²⁺, Co³⁺, Mn²⁺, Mn³⁺, Ni²⁺, Cr²⁺, Cr³⁺, Rh³⁺, Ru²⁺, Ir³⁺,
   M¹ and M² are alike or different,
X is an anion selected from the group comprising halide, hydroxide, sulfate, hydrogen sulfate, carbonate, hydrogen carbonate, cyanide, thiocyanate, isocyanate, cyanate, carboxylate, oxalate, nitrate or nitrite (NO₂⁻) or a mixture of two or more of the aforementioned anions, or a mixture of one or more of the aforementioned anions with one of the uncharged species selected from CO, H₂O, and NO,
Y is an anion which is different than X and is selected from the group comprising halide, sulfate, hydrogen sulfate, disulfate, sulfite, sulfonate (═RS₃⁻ with R═C1-C20 alkyl, aryl, C1-C20 alkylaryl), carbonate, hydrogen carbonate, cyanide, thiocyanate, isocyanate, isothiocyanate, cyanate, carboxylate, oxalate, nitrate, nitrite, phosphate, hydrogen phosphate, dihydrogen phosphate, diphosphate, borate, tetraborate, perchlorate, tetrafluoroborate, hexafluorophosphate, and tetraphenylborate,
L is a water-miscible ligand selected from the group comprising alcohols, aldehydes, ketones, ethers, polyethers, esters, polyesters, polycarbonate, ureas, amides, nitriles, and sulfides or mixtures thereof,
P is an organic additive selected from the group comprising polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylamide-co-maleic acid), polyacrylnitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymer, hydroxylethylcellulose, polyacetates, ionic surface- and interface-active compounds, bile acid or salts, esters or amides thereof, carboxylic esters of polyhydric alcohols, and glycosides,

and

a, b, d, g, n, r, s, j, k, and t are integral or fractional numbers greater than zero,

e, f, h and z are integral or fractional numbers greater than or equal to zero,

with

a, b, d, g, n, j, k, and r, and also s and t, being selected so as to ensure electroneutrality,
M³ being hydrogen or an alkali metal or alkaline earth metal, and
M⁴ being alkali metal ions or an ammonium ion (NH₄)⁺ or an alkylammonium ion (R₄N⁺, R₃NH⁺, R₂NH₂₊, RNH₃⁺ with R═C1-C20 alkyl).

In one particularly preferred embodiment of the invention M¹ is Zn²⁺ and M² is Co³⁺ or Co²⁺.

The metals M¹ and M² are alike particularly when they are cobalt, manganese or iron.

The residues of the catalyst may remain in the product obtained or may be neutralized using an acid, preferably hydrochloric acid, sulfuric acid or acetic acid, with the salts being subsequently removable preferably by means, for example, of washing or of ion exchangers. If appropriate, a partial neutralization may take place, and the product may be used further without further removal of the salts.

The optional synthesis component (d) encompasses high molecular mass diols or polyols, by which is meant a number-average molecular weight of at least 400, preferably 400 to 6000.

The compounds in question are more particularly dihydric or polyhydric polyester polyols and polyether polyols, the dihydric polyols being preferred.

Suitable polyester polyols include, in particular, the conventional reaction products of polyhydric alcohols with polybasic carboxylic acids, with the alcoholic component being employed in excess. The polybasic carboxylic acids may be aliphatic, cycloaliphatic, aromatic, heterocyclic or ethylenically unsaturated in nature and may also, if appropriate, carry halogen atom substituents. Instead of the polybasic carboxylic acids it is also possible for their anhydrides to be esterified. Examples of suitable polybasic starting carboxylic acids include the following:

succinic acid, adipic acid, sebacic acid, phthalic acid, isophthalic acid, trimellitic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride or fumaric acid.

Polyhydric alcohols for use in excess include the following: ethane-1,2-diol, propane-1,2-diol, propane-1,3-diol, butane-1,2-diol, butane-1,3-diol, butane-1,4-diol, butene-1,4-diol, butyne-1,4-diol, pentane-1,5-diol and its positional isomers, hexane-1,6-diol, octane-1,8-diol, 1,4-bishydro-xymethylcyclohexane, 2,2-bis-4-hydroxycyclohexyl)propane, 2-methyl-1,3-propanediol, glycerol, trimethylolpropane, trimethylolethane, hexane-1,2,6-triol, butane-1,2,4-triol, diethylene glycol, triethylene glycol, tetraethylene glycol, polyethylene glycol having a molar mass of 378 to 900, preferably of 378 to 678, poly-1,2-propylene glycol or poly-1,3-propanediol with a molar mass of 134 to 1178, preferably 134 to 888, polyTHF having a molar mass of 162 to 2000, preferably between 378 and 1458, with particular preference 378 to 678.

Preference is given to polyester polyols formed from diols and dicarboxylic acids.

Further suitable polyester polyols are the adducts of lactones or lactone mixtures with dihydric alcohols used as starter molecules. Examples of preferred lactones are ε-caprolactone, β-pro-piolactone, γ-butyrolactone or methyl-ε-caprolactone.

Suitable starter molecules are more particularly the low molecular mass dihydric alcohols already specified as synthesis components for the polyester polyols.

Also suitable, of course, are polyesters formed from hydroxycarboxylic acids as synthesis components. Synthesis components (d) suitable as polyesters are, furthermore, also polycarbonates, of the kind obtainable, for example, from phosgene or diphenyl carbonate and, in excess, the low molecular mass dihydric alcohols specified as synthesis components for the polyester polyols.

Suitable synthesis components (d) with polyether polyol suitability include, preferably, polyether diols, of the kind obtainable, for example, by boron trifluoride-catalyzed linking of ethylene oxide, propylene oxide, butylene oxide, tetrahydrofuran, styrene oxide or epichlorohydrin to itself or to one another, or by addition reaction of these compounds, individually or in a mixture, with starter components containing reactive hydrogen atoms, such as water, polyfunctional alcohols or amines such as ethane-1,2-diol, propane-1,3-diol, 1,2- or 2,2-bis(4-hydroxy-phenyl)propane, or aniline. Furthermore, polyether-1,3-diols, examples being trimethylolpropane which is alkoxylated on one OH group and whose alkylene oxide chain is capped with an alkyl radical comprising 1 to 18 C atoms, are synthesis components (d) employed with preference.

Optional synthesis components (e) may be low molecular mass dihydric or polyhydric alcohols, among which the dihydric alcohols are preferred. Low molecular mass here denotes a number-average molecular weight from 62 to 399.

Suitable synthesis components (e) include ethane-1,2-diol, propane-1,2-diol, propane-1,3-diol, butane-1,2-diol, butane-1,3-diol, butane-1,4-diol, butene-1,4-diol, butyne-1,4-diol, pentane-1,5-diol and its positional isomers, hexane-1,6-diol, octane-1,8-diol, 1,4-bishydroxymethylcyclo-hexane, 2,2-bis(4-hydroxycyclohexyl)propane, 2-methyl-1,3-propanediol, hexane-1,2,6-triol, butane-1,2,4-triol, diethylene glycol, triethylene glycol, tetraethylene glycol, low molecular mass polyethylene glycol, poly-1,2-propylene glycol, poly-1,3-propanediol or polyTHF, neopentyl glycol, neopentyl glycol hydroxypivalate, 2-ethyl-1,3-propanediol, 2-methyl-1,3-propanediol, 2-ethyl-1,3-hexanediol, hydroquinone, bisphenol A, bisphenol F, bisphenol B, bisphenol S, 2,2-bis(4-hydroxycyclohexyl)propane, 1,1-, 1,2-, 1,3-, and 1,4-cyclohexanedimethanol, 1,2-, 1,3- or 1,4-cyclohexanediol and also polyhydric alcohols such as trimethylolbutane, trimethylolpropane, pentaerythritol, trimethylolethane, glycerol, ditrimethylolpropane, dipentaerythritol or sugar alcohols such as sorbitol, mannitol, diglycerol, threitol, erythritol, adonitol (ribitol), arabitol (lyxitol), xylitol, dulcitol (galactitol), maltitol or isomalt. Preference is given to using linear 1,ω-dihydroxyalkanes, more preferably butane-1,4-diol and hexane-1,6-diol.

The polyisocyanates (A) generally have the following construction, based on isocyanate groups (calculated as NCO with a molecular weight of 42 g/mol) in synthesis component (a):
(b) 0.5 to 30 wt % of compounds of formula (I) and/or (II), preferably 0.8 to 25 wt % and more preferably 1.0 to 20 wt %,
(c) at least 0.3 wt %, preferably at least 0.5, more preferably at least 1.0, and very preferably at least 1.2 wt %, and also up to 25 wt %, preferably up to 20, more preferably up to 15, and very preferably up to 10 wt %, based on isocyanate-reactive groups in (c),
(d) 0 to 15 wt %, preferably 0 to 10 wt %, more preferably 0 to 5 wt %, and very preferably 0 wt %, based on isocyanate-reactive groups in (d), and
(e) 0 to 15 wt %, preferably 0 to 10 wt %, more preferably 0 to 5 wt %, and very preferably 0 wt %, based on isocyanate-reactive groups in (e).

The NCO content of the polyisocyanates (A) of the invention is generally 13% by weight or more, preferably 14% by weight or more, more preferably 15% by weight or more, and very preferably 16% by weight or more, in conjunction with very good water-dispersibility. Normally 22% by weight is not exceeded.

Whether compound (b) is incorporated into the polyisocyanate or not is not relevant for the present invention. Without wishing to be bound to a theory it is assumed that at least a part of compound (b) of formula (II) is incorporated into polyisocyanate (A) by reaction of at least one free anionic oxygen group or hydroxy group. It is further assumed that the compounds of formula (II) remain in the water phase. For the sake of simplicity the compound (b) is referred to as “incorporated” into polyisocyanate (A) throughout the description, regardless of their actual state of binding.

Preferred polyisocyanates (A) have a fraction of the structural units —[—CH₂—CH₂—O—]—, calculated as 44 g/mol, in relation to the sum of components a)+b)+c)+d)+e), of at least 5%, preferably at least 10%, and more preferably at least 12%, by weight. In general the fraction is not more than 25%, preferably not more than 22%, and more preferably not more than 20% by weight.

The number-average molar weight Mₙ (determined by gel permeation chromatography using THF as solvent and polystyrene as standard) of the polyisocyanates of the invention is generally at least 400, preferably at least 500, more preferably at least 700, and very preferably at least 1000, and is up to 5000, preferably up to 3000, more preferably up to 2000, and very preferably up to 1500.

In general the viscosity of the water-emulsifiable polyisocyanates of the invention is below 10 000 mPa*s, preferably below 9000 mPa*s, more preferably below 8000 mPa*s, very preferably below 7000 mPa*s, and more particularly between 800 and 6000 mPa*s.

The polyisocyanates (A) of the invention are frequently at least partly neutralized with at least one base (A1). Preferably compound (b) is at least partly neutralized before it is incorporated into the polyisocyanate.

The bases in question may be basic alkali metal, alkaline earth metal or ammonium salts, more particularly the sodium, potassium, cesium, magnesium, calcium and barium salts, especially sodium, potassium, and calcium salts, in the form of hydroxides, oxides, hydrogen carbonates or carbonates, preferably in the form of the hydroxides.

Preferred compounds (A1), however, are ammonia or amines, preferably tertiary amines. The tertiary amines in question are preferably those which are exclusively alkyl-substituted and/or cycloalkyl-substituted.

Examples of such amines are trimethylamine, triethylamine, tri-n-butylamine, ethyldiisopropylamine, dimethylbenzylamine, dimethylphenylamine, triethanolamine, cyclopentyldimethylamine, cyclopentyldiethylamine, cyclohexyldimethylamine, and cyclohexyldiethylamine.

Conceivable, though less preferred, are also heterocyclic amines, however, such as pyridine, imidazole, N-alkylated morpholine, piperidine, piperazine or pyrrolidone.

Generally speaking, the base (A1) is used to neutralize 10 to 100 mol % of the acid groups present in (A), preferably 20 to 100 mol %, more preferably 40 to 100 mol %, very preferably 50 to 100 mol %, and more particularly 70 to 100 mol %.

The at least partial neutralization of component (b) in the polyisocyanate (A) can take place before, during or after the preparation of the polyisocyanate (A), preferably after the preparation.

An advantageous composition according to the present invention comprises as compound (A1) an amine of the following formula (III):

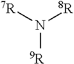

in which R⁷, R⁸ and R⁹ represent a hydrocarbon chain, advantageously selected from cycloalkyl or aryl, it being possible for each of the stated radicals to be substituted by aryl, alkyl, aryloxy, alkyloxy, heteroatoms and/or heterocycles,

It is also possible that the R⁷, R⁸ and R⁹ groups form cyclic structures. R⁷ and R⁸ or R⁸ and R⁹ or R⁷ and R⁹ may thus together form a cyclic structure formed preferably of three to six carbon atoms and optionally containing at least one heteroatom preferably selected from oxygen or sulphur. N-ethyl morpholine, N-methyl morpholine and 1,2,2,6,6-pentamethylpiperidine are examples of cyclic structures of this type.

Advantageously, in the aforementioned formula (III), R⁷, R⁸ and R⁹ represent, independently, a C₁-C₁₈ alkyl substituted if appropriate by aryl, alkyl, aryloxy, alkyloxy, heteroatoms and/or heterocycles or C₆-C₁₂ aryl substituted if appropriate by aryl, alkyl, aryloxy, alkyloxy, heteroatoms and/or heterocycles.

N,N-dimethylcyclohexylamine, ethyldiisopropylamine, dimethylbutylamine, dimethylbenzylamine, triethylamine, trimethylamine, tributylamine, trisopropylamine, methyldioctylamine, methyldidodecylamine, etc. are examples of amines which may be suitable within the scope of the invention.

The polyisocyanates (A) are generally prepared by mixing and reacting the synthesis components in any order. Preference is given to introducing the diisocyanate or polyisocyanate (a) initially, adding the synthesis components (b) and/or (c) together or in succession, and allowing reaction to take place until the reactive groups in (b) and (c) have been converted. Subsequently, if desired, the compounds (d) and/or (e) can be added.

Also conceivable is a reaction regime in which monomeric diisocyanates are reacted with one another as components (a) in the presence of the compounds (b) and/or (c). A reaction regime of this kind is described in WO 2008/116764, hereby fully incorporated by reference as part of the present disclosure content.

The reaction is carried out in general at a temperature of between 40° C. and 170° C., preferably between 45° C. and 160° C., more preferably between 50 and 150° C., and very preferably between 60 and 140° C.

Sterically hindered phenols (B) have the function in the sense of the invention of a primary antioxidant. This is a term commonly used by the skilled person to refer to compounds which scavenge free radicals.

Sterically hindered phenols (B) of this kind are described in WO 2008/116894, for example, preference being given to the compounds described therein at page 14 line 10 to page 16 line 10, hereby made part of the present disclosure content by reference.

The phenols in question are preferably those which have exactly one phenolic hydroxyl group on the aromatic ring, and more preferably those which have a substituent, preferably an alkyl group, in the ortho-positions, very preferably in ortho-position and para-position, to the phenolic hydroxyl group, preferably contain an alkyl group, and more particularly are alkyl 3-(3,5-di-tert-butyl-4-hydroxyphenyl)propionates, or substituted alkyl derivatives of such compounds.

Phenols of this kind may also be constituents of a polyphenolic system having a plurality of phenol groups: pentaerythritol tetrakis(3-(3,5-di-tert-butyl-4-hydroxyphenyl)propionate (e.g., Irganox® 1010); ethylenebis(oxyethylene) bis(3-(5-tert-butyl-4-hydroxy-m-tolyl)propionate) (e.g., Irganox 245); 3,3′,3″,5,5′,5″-hexa-tert-butyl-a,a′,a″-(mesitylene-2,4,6-triyl)tri-p-cresol (e.g., Irganox® 1330); 1,3,5-tris(3,5-di-tert-butyl-4-hydroxybenzyl)-1,3,5-triazine-2,4,6(1H,3H,5H)-trione (e.g., Irganox® 3114), in each case products of Ciba Spezialitätenchemie, now BASF SE.

Corresponding products are available, for example, under the trade names Irganox® (BASF SE), Sumilizer® from Sumitomo, Lowinox® from Great Lakes, and Cyanox® from Cytec.

Also possible are, for example, thiodiethylenebis[3-[3,5-di-tert-butyl-4-hydroxyphenyl]propionate] (Irganox® 1035) and 6,6′-di-tert-butyl-2,2′-thiodi-p-cresol (e.g., Irganox® 1081), each products of BASF SE.

Preference is given to 2,6-di-tert-butyl-4-methylphenol (BHT); isooctyl 3-(3,5-di-tert-butyl-4-hydroxyphenyl)propionate (Irganox® 1135, CAS No. 146598-26-7), octadecyl 3-(3,5-di-tert-butyl-4-hydroxyphenyl)propionate (Irganox® 1076, CAS No. 2082-79-3), and pentaerythritol tetrakis(3-(3,5-di-tert-butyl-4-hydroxyphenyl)propionate (CAS No. 6683-19-8; e.g., Irganox® 1010).

The polyisocyanate composition may further contain a Lewis-acidic organometallic compounds (C) are tin compounds, such as tin(II) salts of organic carboxylic acids, e.g., tin(II) diacetate, tin(II) dioctoate, tin(II) bis(ethylhexanoate), and tin(II) dilaurate, and the dialkyltin(IV) salts of organic carboxylic acids, e.g., dimethyltin diacetate, dibutyltin diacetate, dibutyltin dibutyrate, dibutyltin bis(2-ethylhexanoate), dibutyltin dilaurate, dibutyltin maleate, dioctyltin dilaurate, and dioctyltin diacetate.

Other preferred Lewis-acidic organometallic compounds are zinc salts, example being zinc(II) diacetate and zinc(II) dioctoate.

Tin-free and zinc-free alternatives used include organometallic salts of bismuth, zirconium, titanium, aluminum, iron, manganese, nickel, and cobalt.

These are, for example, zirconium tetraacetylacetonate (e.g., K-KAT® 4205 from King Industries); zirconium dionates (e.g., K-KAT® XC-9213; XC-A 209 and XC-6212 from King Industries); bismuth compounds, especially tricarboxylates (e.g., K-KAT® 348, XC-B221; XC-C227, XC 8203 from King Industries); aluminum dionate (e.g., K-KAT® 5218 from King Industries). Tin-free and zinc-free catalysts are otherwise also offered, for example, under the trade name Borchi® Kat from Borchers, TK from Goldschmidt or BICAT® from Shepherd, Lausanne.

Bismuth catalysts and cobalt catalysts as well, cerium salts such as cerium octoates, and cesium salts can be used as catalysts.

Bismuth catalysts are more particularly bismuth carboxylates, especially bismuth octoates, ethylhexanoates, neodecanoates, or pivalates; examples are K-KAT 348 and XK-601 from King Industries, TIB KAT 716, 716LA, 716XLA, 718, 720, 789 from TIB Chemicals, and those from Shepherd Lausanne, and also catalyst mixtures of, for example, bismuth organyls and zinc organyls.

Further metal catalysts are described by Blank et al. in Progress in Organic Coatings, 1999, Vol. 35, pages 19-29.

These catalysts are suitable for solvent-based, water-based and/or blocked systems.

Molybdenum, tungsten, and vanadium catalysts are described more particularly for the reaction of blocked polyisocyanates in WO 2004/076519 and WO 2004/076520.

Cesium salts as well can be used as catalysts. Suitable cesium salts are those compounds in which the following anions are employed: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻, and also (Cₙ₊₁H₂ₙ₋₂O₄)²⁻, where n stands for the numbers 1 to 20. Preferred here are cesium carboxylates in which the anion conforms to the formulae (CₙH₂ₙ₋₁O₂)⁻ and also (Cₙ₊₁H₂ₙ₋₂O₄)²⁻, with n being 1 to 20. Particularly preferred cesium salts contain monocarboxylate anions of the general formula (CₙH₂ₙ₋₁O₂)⁻, with n standing for the numbers 1 to 20. Particular mention in this context is deserved by formate, acetate, propionate, hexanoate, and 2-ethylhexanoate.

Preferred Lewis-acidic organometallic compounds are dimethyltin diacetate, dibutyltin dibutyrate, dibutyltin bis(2-ethylhexanoate), dibutyltin dilaurate, dioctyltin dilaurate, zinc(II) diacetate, zinc(II) dioctoate, zirconium acetylacetonate, and zirconium 2,2,6,6-tetramethyl-3,5-heptanedionate, and bismuth compounds.

Particular preference is given to dibutyltin dilaurate.

The polyisocyanate composition may further contain a Brønsted acid. (D). Brønsted acids are H-acidic compounds. They are preferably D1) dialkyl phosphates, D2) arylsulfonic acids and/or D3) phosphonates.

Dialkyl phosphates D1 are mono- and di-C₁ to C₁₂ alkyl phosphates and mixtures thereof, preferably the dialkyl phosphates, more preferably those having C₁ to C₈ alkyl groups, very preferably having C₂ to C₈ alkyl groups, and more particularly those having C₄ to C₈ alkyl groups.

The alkyl groups in dialkyl phosphates here may be identical or different, and are preferably identical.

Examples of C₁ to C₁₂ alkyl groups are methyl, ethyl, isopropyl, n-propyl, n-butyl, isobutyl, sec-butyl, tert-butyl, n-hexyl, n-heptyl, n-octyl, n-decyl, n-dodecyl, 2-ethylhexyl, and 2-propylheptyl.

These phosphates are more particularly monoalkyl and dialkyl phosphates and mixtures thereof such as
di(ethylhexyl)phosphate
dibutyl phosphate
diethyl phosphate
Nacure® 4000 (formerly Nacure® C 207), an unspecified alkylphosphoric ester, from King

Industries
Nacure® 4054, an unspecified alkylphosphoric ester, from King Industries
Cycat® 296-9, an unspecified alkylphosphoric ester, from Cytec

Preferred for use in polyisocyanates is use in the form of a 100% product or in a solvent which does not react with isocyanate groups.

Compounds D1 are added generally in amounts, based on the polyisocyanate, of 5 to 1000, preferably 10 to 600, more preferably 20 to 200, very preferably 20 to 80 ppm by weight.

Arylsulfonic acids D2 are, for example, benzene derivatives or naphthalene derivatives, more particularly alkylated benzene or naphthalene derivatives.

Examples of preferred sulfonic acids include 4-alkylbenzenesulfonic acids having alkyl radicals of 6 to 12 C atoms, such as, for example, 4-hexylbenzenesulfonic acid, 4-octylbenzenesulfonic acid, 4-decylbenzenesulfonic acid or 4-dodecylbenzenesulfonic acid. In a manner which is known in principle, the compounds in question here may also be technical products which feature a distribution of different alkyl radicals of different lengths.

Particularly preferred acids include the following:
benzenesulfonic acid
para-toluenesulfonic acid
para-ethylbenzenesulfonic acid
dodecylbenzenesulfonic acid
bisnonylnaphthalenesulfonic acid
bisnonylnaphthalenebissulfonic acid
bisdodecylnaphthalenesulfonic acid
Nacure® XC-C210 (a hydrophobic acid catalyst of unspecified structure from King Industries)

Compounds D1 are added in general in amounts, based on the polyisocyanate, of 1 to 600, preferably 2 to 100, more preferably 5 to 50 ppm by weight.

Phosphonates D3 are phosphorus-containing compounds with a low functionality and an acidic character, more particularly dialkyl phosphonates D3a) and dialkyl diphosphonates D3b).

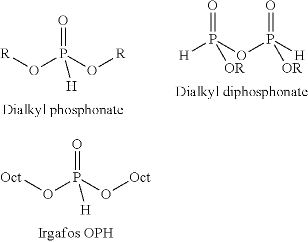

Examples thereof are mono- and di-C₁ to C₁₂ alkyl phosphonates and mixtures thereof, preferably the dialkyl phosphonates, more preferably those having C₁ to C₈ alkyl groups, very preferably having C₁ to C₈ alkyl groups, and more particularly those having C₁, C₂, C₄ or C₈ alkyl groups.

The alkyl groups in dialkyl phosphonates may be identical or different, and are preferably identical.

Examples of C₁ to C₁₂ alkyl groups are methyl, ethyl, isopropyl, n-propyl, n-butyl, isobutyl, sec-butyl, tert-butyl, n-hexyl, n-heptyl, n-octyl, n-decyl, n-dodecyl, 2-ethylhexyl, and 2-propylheptyl.

The examples described in WO 2008/116895 are hereby part of the present disclosure content. Specific examples that may explicitly be given include the following:
dioctyl phosphonate, di-n-octyl phosphonate Irgafos® OPH (see image above)
di-(2-ethylhexyl) phosphonate
diethyl phosphonate

Compounds D3 are generally in amounts, based on the polyisocyanate, of 10 to 1000, preferably 20 to 600, more preferably 50 to 300 ppm by weight.

It is possible as well, furthermore, for a solvent or solvent mixture (E) to be present.

Solvents which can be used for the polyisocyanate component, and also for the binder and any other components, are those which contain no groups that are reactive toward isocyanate groups or blocked isocyanate groups, and in which the polyisocyanates are soluble to an extent of at least 10%, preferably at least 25%, more preferably at least 50%, very preferably at least 75%, more particularly at least 90%, and especially at least 95% by weight.

Examples of solvents of this kind are aromatic hydrocarbons (including alkylated benzenes and naphthalenes) and/or (cyclo)aliphatic hydrocarbons and mixtures thereof, chlorinated hydrocarbons, ketones, esters, alkoxylated alkyl alkanoates, ethers, and mixtures of the solvents.

Preferred aromatic hydrocarbon mixtures are those which comprise predominantly aromatic C₇ to C₁₄ hydrocarbons and may encompass a boiling range from 110 to 300° C.; particular preference is given to toluene, o-, m- or p-xylene, trimethylbenzene isomers, tetramethylbenzene isomers, ethylbenzene, cumene, tetrahydronaphthalene, and mixtures comprising them.

Examples thereof are the Solvesso® products from ExxonMobil Chemical, especially Solvesso® 100 (CAS No. 64742-95-6, predominantly C₉ and C₁₀ aromatics, boiling range about 154-178° C.), 150 (boiling range about 182-207° C.), and 200 (CAS No. 64742-94-5), and also the Shellsol® products from Shell, Caromax® (e.g., Caromax® 18) from Petrochem Carless, and Hydrosol from DHC (e.g., as Hydrosol® A 170). Hydrocarbon mixtures comprising paraffins, cycloparaffins, and aromatics are also available commercially under the names Kristalloel (for example, Kristalloel 30, boiling range about 158-198° C. or Kristalloel 60: CAS No. 64742-82-1), white spirit (for example likewise CAS No. 64742-82-1) or solvent naphtha (light: boiling range about 155-180° C., heavy: boiling range about 225-300° C.). The aromatics content of such hydrocarbon mixtures is generally more than 90%, preferably more than 95%, more preferably more than 98%, and very preferably more than 99% by weight. It may be advisable to use hydrocarbon mixtures having a particularly reduced naphthalene content.

Examples of (cyclo)aliphatic hydrocarbons include decalin, alkylated decalin, and isomer mixtures of linear or branched alkanes and/or cycloalkanes.

The amount of aliphatic hydrocarbons is generally less than 5%, preferably less than 2.5%, and more preferably less than 1% by weight.

Esters are, for example, propylene glycol diacetate, n-butyl acetate, ethyl acetate, 1-methoxyprop-2-yl acetate, and 2-methoxyethyl acetate.

Ethers are, for example, THF, dioxane, and also the dimethyl, diethyl or di-n-butyl ethers of ethylene glycol, diethylene glycol, triethylene glycol, propylene glycol, dipropylene glycol or tripropylene glycol.

Ketones are, for example, acetone, diethyl ketone, ethyl methyl ketone, isobutyl methyl ketone, methyl amyl ketone and tert-butyl methyl ketone.

Preferred solvents are n-butyl acetate, ethyl acetate, propylene glycol diacetate, 1-methoxy-prop-2-yl acetate, 2-methoxyethyl acetate, and also mixtures thereof, more particularly with the aromatic hydrocarbon mixtures recited above, especially xylene and Solvesso® 100.

Mixtures of this kind may be prepared in a volume ratio of 5:1 to 1:5, preferably in a volume ratio of 4:1 to 1:4, more preferably in a volume ratio of 3:1 to 1:3, and very preferably in a volume ratio of 2:1 to 1:2.

Preferred examples are butyl acetate/xylene, methoxypropyl acetate/xylene 1:1, butyl acetate/solvent naphtha 100 1:1, butyl acetate/Solvesso® 100 1:2, and Kristalloel 30/Shellsol® A 3:1.

Preference is given to butyl acetate, 1-methoxyprop-2-yl acetate, methyl amyl ketone, xylene, and Solvesso® 100.

Surprisingly it has been found that the solvents are differently problematic in relation to the stated object. Polyisocyanate compositions as per the patent which comprise ketones or mixtures of aromatics (solvent naphtha mixtures, for example) are particularly critical in respect of development of color number on storage. In contrast, esters, ethers, and certain aromatics cuts such as xylene and its isomer mixtures are less problematic. This is surprising insofar as xylenes, in the same way as the mixtures of aromatics, likewise carry benzylic hydrogen atoms, which could play a part in the development of color. A further factor is that solvent naphtha mixtures, depending on the source and storage time, can have significantly different effects on color number drift if used in the polyisocyanate compositions.

Further, typical coatings additives (F) used may be the following, for example: other antioxidants, UV stabilizers such as UV absorbers and suitable free-radical scavengers (especially HALS compounds, hindered amine light stabilizers), activators (accelerators), drying agents, fillers, pigments, dyes, antistatic agents, flame retardants, thickeners, thixotropic agents, surface-active agents, viscosity modifiers, plasticizers or chelating agents. UV stabilizers are preferred.

Other primary antioxidants are, for example, secondary arylamines.

The secondary antioxidants are preferably selected from the group consisting of phosphites, phosphonites, phosphonates, and thioethers.

Phosphites are compounds of the type P(OR^{a})(OR^{b}) (OR^{c}) with R^{a}, R^{b}, and R^{c} being identical or different, aliphatic or aromatic radicals (which may also form cyclic or spiro structures).

Preferred phosphonites are described in WO 2008/116894, particularly from page 11 line 8 to page 14 line 8 therein, hereby made part of the present disclosure content by reference.

Preferred phosphonates are described in WO 2008/116895, particularly from page 10 line 38 to page 12 line 41 therein, hereby made part of the present disclosure content by reference.

These are more particularly dialkyl phosphonates and dialkyl diphosphonates.

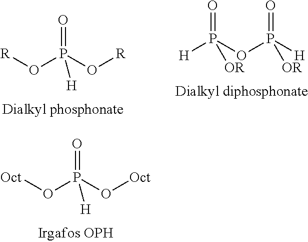

Examples thereof are mono- and di-C₁ to C₁₂ alkyl phosphonates and mixtures thereof, preferably the dialkyl phosphonates, more preferably those having C₁ to C₈ alkyl groups, very preferably having C₁ to C₈ alkyl groups, and more particularly those having C₁, C₂, C₄ or C₈ alkyl groups.

The alkyl groups in dialkyl phosphonates may be identical or different, and are preferably identical.

Examples of C₁ to C₁₂ alkyl groups are methyl, ethyl, isopropyl, n-propyl, n-butyl, isobutyl, sec-butyl, tert-butyl, n-hexyl, n-heptyl, n-octyl, n-decyl, n-dodecyl, 2-ethylhexyl, and 2-propylheptyl, more particularly di-n-octyl phosphonate Irgafos® OPH (see image above), and di-(2-ethylhexyl) phosphonate.

Preferred thioethers described in WO 2008/116893, particularly from page 11 line 1 to page 15 line 37 therein, hereby made part of the present disclosure content by reference.

Suitable UV absorbers comprise oxanilides, triazines and benzotriazole (the latter available, for example, as Tinuvin® products from BASF SE) and benzophenones (e.g., Chimassorb® 81 from BASF SE). Preference is given, for example, to 95% benzenepropanoic acid, 3-(2H-benzo-triazol-2-yl)-5-(1,1-dimethylethyl)-4-hydroxy-, C7-9-branched and linear alkyl esters; 5% 1-methoxy-2-propyl acetate (e.g., Tinuvin® 384) and α-[3-[3-(2H-benzotriazol-2-yl)-5-(1,1-dimethyl-ethyl)-4-hydroxyphenyl]-1-oxopropyl]-w-hydroxypoly(oxo-1,2-ethanediyl) (e.g., Tinuvin® 1130), in each case products, for example, of BASF SE. DL-alpha-Tocopherol, tocopherol, cinnamic acid derivatives, and cyanoacrylates can likewise be used for this purpose.

These can be employed alone or together with suitable free-radical scavengers, examples being sterically hindered amines (often also identified as HALS or HAS compounds; hindered amine (light) stabilizers) such as 2,2,6,6-tetramethylpiperidine, 2,6-di-tert-butylpiperidine or derivatives thereof, e.g., bis(2,2,6,6-tetramethyl-4-piperidyl) sebacate. They are obtainable, for example, as Tinuvin® products and Chimassorb® products from BASF SE. Preference in joint use with Lewis acids, however, is given to those hindered amines which are N-alkylated, examples being bis(1,2,2,6,6-pentamethyl-4-piperidinyl) [[3,5-bis(1,1-dimethylethyl)-4-hydroxy-phenyl]methyl]butylmalonate (e.g., Tinuvin® 144 from BASF SE); a mixture of bis(1,2,2,6,6-pen-tamethyl-4-piperidinyl)sebacate and methyl(1,2,2,6,6-pentamethyl-4-piperidinyl) sebacate (e.g., Tinuvin® 292 from BASF SE); or which are N—(O-alkylated), such as, for example, decanedioic acid bis(2,2,6,6-tetramethyl-1-(octyloxy)-4-piperidinyl) ester, reaction products with 1,1-dimethyl-ethyl hydroperoxide and octane (e.g., Tinuvin® 123 from BASF SE) and especially the HALS triazine “2-aminoethanol, reaction products with cyclohexane and peroxidized N-butyl-2,2,6,6-tetramethyl-4-piperidinamine-2,4,6-trichloro-1,3,5-triazine reaction product” (e.g., Tinuvin® 152 from BASF SE).

UV stabilizers are used typically in amounts of 0.1% to 5.0% by weight, based on the solid components present in the preparation.

Suitable thickeners include, in addition to free-radically (co)polymerized (co)polymers, typical organic and inorganic thickeners such as hydroxymethylcellulose or bentonite.

Chelating agents which can be used include, for example, ethylenediamineacetic acid and salts thereof and also β-diketones.

As component (G) in addition it is possible for fillers, dyes and/or pigments to be present.

Pigments in the true sense are, according to CD Römpp Chemie Lexikon—Version 1.0, Stuttgart/New York: Georg Thieme Verlag 1995, with reference to DIN 55943, particulate “colorants that are organic or inorganic, chromatic or achromatic and are virtually insoluble in the application medium”.

Virtually insoluble here means a solubility at 25° C. below 1 g/1000 g application medium, preferably below 0.5, more preferably below 0.25, very particularly preferably below 0.1, and in particular below 0.05 g/1000 g application medium.

Examples of pigments in the true sense comprise any desired systems of absorption pigments and/or effect pigments, preferably absorption pigments. There are no restrictions whatsoever on the number and selection of the pigment components. They may be adapted as desired to the particular requirements, such as the desired perceived color, for example, as described in step a), for example. It is possible for example for the basis to be all the pigment components of a standardized mixer system.

Effect pigments are all pigments which exhibit a platelet-shaped construction and give a surface coating specific decorative color effects. The effect pigments are, for example, all of the pigments which impart effect and can be used typically in vehicle finishing and industrial coatings.

Examples of such effect pigments are pure metallic pigments, such as aluminum, iron or copper pigments; interference pigments, such as titanium dioxide-coated mica, iron oxide-coated mica, mixed oxide-coated mica (e.g., with titanium dioxide and Fe₂O₃ or titanium dioxide and Cr₂O₃), metal oxide-coated aluminum; or liquid-crystal pigments, for example.

The coloring absorption pigments are, for example, typical organic or inorganic absorption pigments that can be used in the coatings industry. Examples of organic absorption pigments are azo pigments, phthalocyanine pigments, quinacridone pigments, and pyrrolopyrrole pigments. Examples of inorganic absorption pigments are iron oxide pigments, titanium dioxide, and carbon black.

Dyes are likewise colorants, and differ from the pigments in their solubility in the application medium; i.e., they have a solubility at 25° C. of more than 1 g/1000 g in the application medium.

Examples of dyes are azo, azine, anthraquinone, acridine, cyanine, oxazine, polymethine, thiazine, and triarylmethane dyes. These dyes may find application as basic or cationic dyes, mordant dyes, direct dyes, disperse dyes, development dyes, vat dyes, metal complex dyes, reactive dyes, acid dyes, sulfur dyes, coupling dyes or substantive dyes.

Coloristically inert fillers are all substances/compounds which on the one hand are coloristically inactive, i.e., exhibit a low intrinsic absorption and have a refractive index similar to that of the coating medium, and which on the other hand are capable of influencing the orientation (parallel alignment) of the effect pigments in the surface coating, i.e., in the applied coating film, and also properties of the coating or of the coating compositions, such as hardness or rheology, for example. Inert substances/compounds which can be used are given by way of example below, but without restricting the concept of coloristically inert, topology-influencing fillers to these examples. Suitable inert fillers meeting the definition may be, for example, transparent or semitransparent fillers or pigments, such as silica gels, blanc fixe, kieselguhr, talc, calcium carbonates, kaolin, barium sulfate, magnesium silicate, aluminum silicate, crystalline silicon dioxide, amorphous silica, aluminum oxide, microspheres or hollow microspheres made, for example, of glass, ceramic or polymers, with sizes of 0.1-50 μm, for example. Additionally as inert fillers it is possible to employ any desired solid inert organic particles, such as urea-formaldehyde condensates, micronized polyolefin wax and micronized amide wax, for example. The inert fillers can in each case also be used in a mixture. It is preferred, however, to use only one filler in each case.

Preferred fillers comprise silicates, examples being silicates obtainable by hydrolysis of silicon tetrachloride, such as Aerosil® from Degussa, siliceous earth, talc, aluminum silicates, magnesium silicates, calcium carbonates, etc.

The constitution of the polyisocyanate compositions of the invention is for example as follows:
(A) 20% to 99.998%, preferably 30% to 90%, more preferably 40-80% by weight,
(B) 10 to 2500 ppm, preferably 250 to 1000 ppm, more preferably 50 to 500 ppm by weight,
(C) 0 to 10 000 ppm, preferably 20 to 2000 ppm, and more preferably 50 to 1000 ppm by weight,
(D) 0 to 1000 ppm, preferably 5 to 300 ppm, more preferably 10 to 50 ppm by weight, and
(E) 0% to 80%, preferably 10-70%, more preferably 20% to 60% by weight,
(F) 0-5% additives, with the proviso that the sum always makes 100% by weight.
(G) optionally pigments additionally to components (A) to (F) above.

Where components (G) are present, they are not included in the composition of components (A) to (F).

The polyisocyanate compositions of the invention can be used with advantage as curing agent components additionally to at least one binder in polyurethane coating materials.

The reaction with binders may take place, where appropriate, after a long period of time, necessitating storage of the polyisocyanate composition accordingly. Although polyisocyanate composition is stored preferably at room temperature, it can also be stored at higher temperatures. In industry, heating of such polyisocyanate compositions to 40° C., 60° C. and even up to 80° C. is entirely possible.

The binders may be, for example, aqueous solutions, emulsions or dispersions of polyols: polyacrylate-ol, polyester-ol, poly-urethane-ol, polyether-ol, and polycarbonate-ol dispersions, and also their hybrids and/or mixtures of the stated polyols. Hybrids means graft copolymers and other chemical reaction products which include chemically attached molecular moieties having different (or else like) groups from among those stated. Preference is given to polyacrylate-polyol dispersions, polyester-polyol dispersions, polyether-polyol dispersions, polyurethane-polyol dispersions, polycarbonate-polyol dispersions, and their hybrids.

Polyacrylate-ols can be prepared as primary or secondary dispersions, emulsions, and solutions. They are prepared from olefinically unsaturated monomers. These are, firstly, comonomers containing acid groups, having for example carboxylic, sulfonic acid and/or phosphonic acid groups or their salts, such as (meth)acrylic acid, vinylsulfonic acid or vinylphosphonic acid, for example. These are, secondly, comonomers containing hydroxyl groups, such as hydroxyalkyl esters or amides of (meth)acrylic acid, such as 2-hydroxyethyl and 2 or 3-hydroxypropyl (meth)acrylate, for example. These are, thirdly, unsaturated comonomers which contain neither acidic groups nor hydroxyl groups, such as alkyl esters of (meth)acrylic acid, styrene and derivatives, (meth)acrylonitrile, vinyl esters, vinyl halides, vinyl imidazole, etc. The properties can be influenced, for example, via the composition of the polymer, and/or, for example, via the glass transition temperatures of the comonomers (with different hardness).

Polyacrylate-ols for aqueous applications are described for example in EP 358979 (U.S. Pat. No. 5,075,370), EP 557844 (U.S. Pat. No. 6,376,602), EP 1141066 (U.S. Pat. No. 6,528,573) or 496210 (U.S. Pat. No. 5,304,400). One example of a commercially available secondary polyacrylate emulsion is Bayhydrol® A 145 (a product of Bayer MaterialScience). Examples of a primary polyacrylate emulsion are Bayhydrol® VP LS 2318 (a product of Bayer MaterialScience) and Luhydran® products from BASF AG.

Other examples are Macrynal® VSM 6299w/42WA from Cytec, and Setalux® AQ products from Nuplex Resins, such as Setalux® 6510 AQ-42, Setalux® 6511 AQ-47, Setalux® 6520 AQ-45, Setalux® 6801 AQ-24, Setalux® 6802 AQ-24, and Joncryl® from BASF Resins.

Polyacrylate-ols may also have a heterogeneous structure, as is the case for core-shell structures.

Polyester-ols for aqueous applications are described for example in EP 537568 (U.S. Pat. No. 5,344,873), EP 610450 (U.S. Pat. No. 6,319,981, polycondensation resin), and EP 751197 (U.S. Pat. No. 5,741,849, polyester-polyurethane mixture). Polyester-ols for aqueous applications are, for example, WorléePol products from Worlée-Chemie GmbH, Necowel® products from Ashland-Südchemie-Kernfest GmbH, and Setalux® 6306 SS-60 from Nuplex Resins.

Polyurethane-polyol dispersions for aqueous applications are described for example in EP 469389 (U.S. Pat. No. 559,805). They are marketed, for example, under the brand name Daotan® from DSM NV.

Polyether-ols for aqueous applications are described for example in EP 758007.

Hybrids and mixtures of the various polyols are described for example in EP 424705 (U.S. Pat. No. 417,998), EP 496205 (U.S. Pat. No. 5,387,642), EP 542085 (5308912, polyacrylate/polyether mixture), EP 542105 (U.S. Pat. No. 5,331,039), EP 543228 (U.S. Pat. No. 5,336,711, polyester/polyacrylate hybrids), EP 578940 (U.S. Pat. No. 5,349,041, polyester/urethane/carbonate), EP 758007 (U.S. Pat. No. 5,750,613, polyacrylate-polyether mixture), EP 751197 (U.S. Pat. No. 5,741,849), EP 1141065 (U.S. Pat. No. 6,590,028).

Polyesters/polyacrylates are described for example in EP 678536 (U.S. Pat. No. 5,654,391). One example of a secondary polyester/polyacrylate emulsion is Bayhydrol® VP LS 2139/2 (a product of Bayer MaterialScience).

To incorporate the water-emulsifiable polyisocyanates of the invention it is generally enough to distribute the inventively obtained polyisocyanate in the aqueous dispersion of the polyol. Generating the emulsion generally requires an energy input of 0 to not more than 10⁸ W/m³.

The dispersions generally have a solids content of 10% to 85%, preferably of 20% to 70% by weight and a viscosity of 10 to 500 mPa*s.

For the curing of the film, polyisocyanate composition and binder are mixed with one another in a molar ratio of isocyanate groups to isocyanate-reactive groups of 0.2:1 to 5:1, preferably 0.8:1 to 1.2:1, and especially 0.9:1 to 1.1:1, and any further, typical coating constituents may optionally be incorporated by mixing, and the resulting material is applied to the substrate and cured at ambient temperature to 150° C.

In one preferred variant the coating material mixture is cured at ambient temperature to 80° C., more preferably to 60° C. (e.g., for refinish applications or large articles which are difficult to place into an oven).

In another preferred application, the coating material mixture is cured at 110-150° C., preferably at 120-140° C. (e.g., for OEM applications).

“Curing” in the context of the present invention refers to the production of a tack-free coating on a substrate, by the heating of the coating composition, applied to the substrate, at the temperature indicated above at least until at least the desired tack-free state has come about.

A coating composition in the context of the present specification means a mixture at least of the components provided for the coating of at least one substrate for the purpose of forming a film and, after curing, a tack-free coating.

The substrates are coated by typical methods known to the skilled person, with at least one coating composition being applied in the desired thickness to the substrate to be coated, and the optionally present volatile constituents of the coating composition being removed, optionally with heating. This operation may if desired be repeated one or more times. Application to the substrate may take place in a known way, as for example by spraying, troweling, knifecoating, brushing, rolling, rollercoating, flowcoating, laminating, injection backmolding or coextruding.

The thickness of a film of this kind for curing may be from 0.1 μm up to several mm, preferably from 1 to 2000 μm, more preferably 5 to 200 μm, very preferably from 5 to 60 μm (based on the coating material in the state in which the solvent has been removed from the coating material).

Additionally provided by the present invention are substrates coated with a multicoat paint system of the invention.

Polyurethane coating materials of this kind are especially suitable for applications requiring particularly high application reliability, exterior weathering resistance, optical qualities, solvent resistance, chemical resistance, and water resistance.

The two-component coating compositions and coating formulations obtained are suitable for coating substrates such as wood, wood veneer, paper, cardboard, paperboard, textile, film, leather, nonwoven, plastics surfaces, glass, ceramic, mineral building materials, such as molded cement blocks and fiber-cement slabs, or metals, which in each case may optionally have been precoated or pretreated.

Coating compositions of this kind are suitable as or in interior or exterior coatings, i.e., in those applications where there is exposure to daylight, preferably of parts of buildings, coatings on (large) vehicles and aircraft, and industrial applications, utility vehicles in agriculture and construction, decorative coatings, bridges, buildings, power masts, tanks, containers, pipelines, power stations, chemical plants, ships, cranes, posts, sheet piling, valves, pipes, fittings, flanges, couplings, halls, roofs, and structural steel, furniture, windows, doors, woodblock flooring, can coating and coil coating, for floor coverings, such as in parking levels or in hospitals and in particular in automotive finishes, as OEM and refinish application.

Coating compositions of this kind are used preferably at temperatures between ambient temperature to 80° C., preferably to 60° C., more preferably to 40° C. The articles in question are preferably those which cannot be cured at high temperatures, such as large machines, aircraft, large-capacity vehicles, and refinish applications.

In particular the coating compositions of the invention are used as clearcoat, basecoat, and topcoat material(s), primers, and surfacers.

It is an advantage of the polyisocyanate compositions of the invention that they maintain the color stability of polyisocyanate mixtures over a long time period.

Polyisocyanate compositions of this kind can be employed as curing agents in coating materials, adhesives, and sealants.

By virtue of their low color number and high color stability they are of interest more particularly for coating compositions for clearcoat materials. Refinish applications are more particularly preferred.

### EXAMPLES

Raw Materials:

Polyisocyanate A:

HDI-Isocyanurate with a NCO content of 22.0% and a viscosity of 3000 mPa*s at 23° C. (Basonat® HI 100 NG from BASF SE).

Polyether C:

Monofunctional poly(ethylene oxide), started with a methanol and using potassium hydroxide-based catalysis, with a OH content of 112 (DIN 53240) and an average molecular weight of 500 g/mol. The product was neutralized with acetic acid and the different remaining potassium salts removed.

Phosphate Salt D:

Mixture of 40.0 g Dibutyl/monobutylphosphate (molar ratio 0.8/1.0) and 19.0 g triethylamine

Polyisocyanate Crosslinker Synthesis:

Polyisocyanate 1:

908.0 g Polyisocyanate A, 28.3 g Polyether C and 63.6 g Phoshphate Salt D are charged to a 1000 mL, 3-neck round bottom flask equipped with a thermometer (coupled with a temperature regulated oil-bath), mechanical stirring, a cold water condenser and nitrogen inlet. The reaction mixture is stirred and heated at 90° C. After 3 hours, the NCO content reached a value of 19.0%. The reaction mixture is cooled down to room temperature and the corresponding polyisocyanate presented a viscosity of 4200 mPa·s at 23° C.

Storage Test:

| | Solvent/ | Stabilizer/ | | Initial | Final |
|---|---|---|---|---|---|
| Hardener | dilution | quantities | Storage | color | color |
| PIC1 | 70 wt% | No | 21 Days | 75 | 335 |
| | in PGDA | Stabilizer | @ 50° C. | | |
| PIC1 | 70 wt% | 500 ppm | 21 Days | 75 | 382 |
| | in PGDA | Irgafos OPH | @ 50° C. | | |
| PIC1 | 70 wt% | 500 ppm | 21 Days | 75 | 384 |
| | in PGDA | DEHP | @ 50° C. | | |
| PIC1 | 70 wt% | 500 ppm | 21 Days | 75 | 81 |
| | in PGDA | BHT | @ 50° C. | | |
| PIC1 | 70 wt% | 500 ppm | 21 Days | 75 | 97 |
| | in PGDA | Irganox 1135 | @ 50° C. | | |
| PIC1 | 70 wt% | No | 21 Days | 69 | 206 |
| | in MPA | Stabilizer | @ 50° C. | | |
| PIC1 | 70 wt% | 500 ppm | 21 Days | 69 | 242 |
| | in MPA | Irgafos OPH | @ 50° C. | | |
| PIC1 | 70 wt% | 500 ppm | 21 Days | 69 | 210 |
| | in MPA | DEHP | @ 50° C. | | |
| PIC1 | 70 wt% | 500 ppm | 21 Days | 69 | 69 |
| | in MPA | BHT | @ 50° C. | | |
| PIC1 | 70 wt% | 500 ppm | 21 Days | 69 | 95 |
| | in MPA | Irganox 1135 | @ 50° C. | | |
| PIC1 | 100%-No | No | 14 Days | 70 | 554 |
| | Solvent | Stabilizer | @ 50° C. | | |
| PIC1 | 100%-No | 100 ppm | 14 Days | 70 | 71 |
| | Solvent | Irganox 1135 | @ 50° C. | | |
| PIC1 | 100%-No | 250 ppm | 14 Days | 70 | 58 |
| | Solvent | Irganox 1135 | @ 50° C. | | |
| PIC1 | 100%-No | 500 ppm | 14 Days | 70 | 69 |
| | Solvent | Irganox 1135 | @ 50° C. | | |
| PIC1 | 100%-No | 500 ppm | 14 Days | 70 | 538 |
| | Solvent | Irgafos OPH | @ 50° C. | | |
| PIC1 | 100%-No | 500 ppm | 14 Days | 70 | 612 |
| | Solvent | DEHP | @ 50° C. | | |

PGDA: Propyleneglycoldiacetate
MPA: 1-Methoxy-2-propylacetat
Irgafos OPH: Di n-octylphosphonic acid
DEHP: Di-2-ethylhexylphosphate
BHT: Butylhydroxytoluol

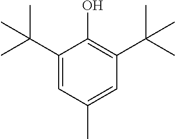 [SMILES: Cc1cc(C(C)(C)C)c(O)c(C(C)(C)C)c1]

Irganox 1135: benzenepropanoic acid, 3,5-bis (1,1-dimethyl-ethyl)-4-hydroxy-C7-C9 branched alkyl esters

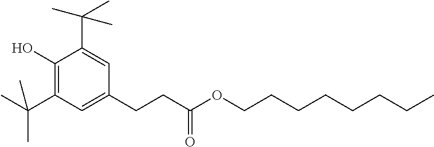 [SMILES: CCCCCCCCOC(=O)CCc1cc(C(C)(C)C)c(O)c(C(C)(C)C)c1]

1.-16. (canceled)

17. A polyisocyanate composition comprising
(A) at least one polyisocyanate obtained by reacting
(a) at least one diisocyanate or polyisocyanate,
(b) at least one surfactant comprising a mixture of compounds based on the following formulae (I) and (II): 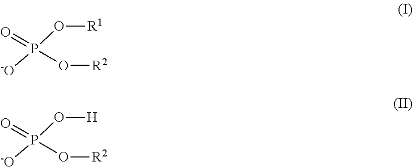
in which
R¹ and R² independently of one another are alkyl, cycloalkyl or aryl, it being possible for each of the stated radicals to be substituted by aryl, alkyl, aryloxy, alkyloxy, heteroatoms and/or heterocycles,
said mixture of compounds of formulae (I) and (II) being characterised in that the molar ratio between compound (II), i.e. the monoester-type compound, and compound (I), i.e. the diester-type compound, is from 5:95 to 95:5,
and
(c) at least one monofunctional polyalkylene glycol,
and (B) at least one sterically hindered phenol.

18. The polyisocyanate composition according to claim 17, wherein component (a) is a polyisocyanate synthesized from (cyclo)aliphatic isocyanates.

19. The polyisocyanate composition according to claim 17, wherein component (a) is a polyisocyanate containing allophanate and/or isocyanurate groups which is based on isophorone diisocyanate and/or 1,6-hexamethylene diisocyanate.

20. The polyisocyanate composition according to claim 17, wherein in component (b) R¹ and R² independently of one another are unsubstituted alkyl or unsubstituted aryl.

21. The polyisocyanate composition according to claim 20, wherein R¹ and R² independently of one another are selected from the group consisting of phenyl, methyl, ethyl, n-butyl, and 2-ethylhexyl.

22. The polyisocyanate composition according to claim 17, wherein the compound (b) is selected from the group consisting of mono methyl phosphate, di methyl phosphate, mono ethyl phosphate, di ethyl phosphate, mono n-butyl phosphate, di n-butyl phosphate, mono 2-ethylhexyl phosphate, di 2-ethylhexyl phosphate, and mixtures thereof.

23. The polyisocyanate composition according to claim 17, wherein the compound (c) fulfills the formula
R⁴—O—[—Xᵢ—]ₖ—H
in which
R⁴ is C₁-C₂₀ alkyl, C₂-C₂₀ alkyl uninterrupted or interrupted by one or more oxygen and/or sulfur atoms and/or by one or more substituted or unsubstituted imino groups, or is C₆-C₁₂ aryl, C₅-C₁₂ cycloalkyl or a five- or six-membered heterocycle containing oxygen, nitrogen and/or sulfur atoms, it being possible for each of the stated radicals to be substituted by functional groups, aryl, alkyl, aryloxy, alkyloxy, halogen, heteroatoms and/or heterocycles,
k is an integer from 5 to 40, and
each Xᵢ for i=1 to k can be selected independently from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂ in which Ph is phenyl and Vin is vinyl.

24. The polyisocyanate composition according to claim 17, having the following construction of polyisocyanate (A), based on isocyanate groups in synthesis component (a):
(b) 0.5 to 30 wt % of compounds of formula (I) and/or (II), and
(c) at least 0.3 wt % up to 25 wt %, based on isocyanate-reactive groups in (c).

25. The polyisocyanate composition according to claim 17, wherein the phosphate groups in compound (b) have been at least partly neutralized.

26. The polyisocyanate composition according to claim 25, wherein the phosphate groups have been at least partly neutralized with tertiary amines (A1).

27. The polyisocyanate composition according to claim 17, wherein compound (B) is selected from the group consisting of 2,6-bis-tert-butyl-4-methylphenol (BHT), 3-[3,5-di-tert-butyl-4-hydroxyphenyl]propionic ester, pentaerythritol tetrakis(3-(3,5-di-tert-butyl-4-hydroxyphenyl)propionate), 3,3′,3″,5,5′,5″-hexa-tert-butyl-a,a′,a″-(mesitylene-2,4,6-triyl)tri-p-cresol, 1,3,5-tris(3,5-di-tert-butyl-4-hydroxybenzyl)-1,3,5-triazine-2,4,6(1H,3H,5H)-trione, isooctyl 3-(3,5-di-tert-butyl-4-hydroxyphenyl)propionate, and octadecyl 3-(3,5-di-tert-butyl-4-hydroxyphenyl)propionate.

28. A method of stabilizing a polyisocyanate composition comprising in addition to polyisocyanate (A) at least one sterically hindered phenol (B).

29. A process for preparing a polyurethane coating material, which comprises reacting a polyisocyanate composition according to claim 17 with at least one binder which comprises isocyanate-reactive groups.

30. A process for preparing a polyurethane coating material, which comprises reacting a polyisocyanate composition according to claim 17 with at least one binder selected from the group consisting of polyacrylate-polyol dispersions, polyester-polyol dispersions, polyether-polyol dispersions, polyurethane-polyol dispersions, polycarbonate-polyol dispersions, and their hybrids.

31. The use of a polyisocyanate composition according to claim 17 as a curing agent in a coating composition, in primers, surfacers, pigmented topcoat, basecoat, and clearcoat materials in the segment of refinish, in automotive refinish, large-vehicle coating, and wood coating, and also as a curing agent in coating materials, adhesives, and sealants.

32. The use of at least one sterically hindered phenol (B) for reducing the color number of mixtures comprising at least one polyisocyanate (A), obtained by reacting
(a) at least one at diisocyanate or polyisocyanate,
(b) at least one surfactant comprising an amine and a mixture of compounds based on the following formulae (I) and (II): 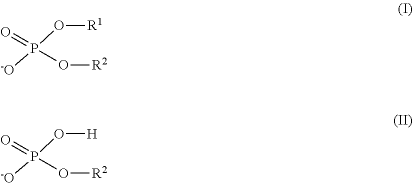
in which
R¹ and R² independently of one another are alkyl, cycloalkyl or aryl, it being possible for each of the stated radicals to be substituted by aryl, alkyl, aryloxy, alkyloxy, heteroatoms and/or heterocycles,
said mixture of compounds of formulae (I) and (II) being characterized in that the molar ratio between compound (II), i.e. the monoester-type compound, and compound (I), i.e. the diester-type compound, is from 5:95 to 95:5,
and
(c) at least one monofunctional polyalkylene glycol.
